(19) United States
(12) Patent Application Publication
(10) Pub. No.: US 2017/0210300 A1
(43) Pub. Date: Jul. 27, 2017

(54) Air Drag Improvement Attachment for Rack and Load

(71) Applicant: EcoCap USA, LLC, St. Francis, WI (US)

(72) Inventor: Brian Roe, St. Francis, WI (US)

(21) Appl. No.: 15/410,041

(22) Filed: Jan. 19, 2017

Related U.S. Application Data
(60) Provisional application No. 62/286,015, filed on Jan. 22, 2016.

(51) Int. Cl. B60R 9/05

(52) U.S. Cl. CPC B60R 9/05

(57) ABSTRACT

An attachment is intended to be affixed to a vehicle's ladder rack to improve the air drag of both the ladder rack and load attached thereto. The location of the attachment allows it to perform the intended function of creating an adjusted wind flow which would otherwise hit both the ladder rack and the load directly causing a drag force. The drag force results in increased fuel consumption. The attachment therefore increases the safety of the attached load, vehicle, and driver, as the load and vehicle are not jostled around by drag force caused by the wind flow.

### CROSS REFERENCE TO RELATED APPLICATION

This application claims the benefit of US Provisional Application 62/286,015 filed Jan. 22, 2016 and is hereby incorporated by reference.

### BACKGROUND OF THE INVENTION

1. Field of the Invention

The present invention relates generally to reducing the air drag on a moving vehicle caused by a rack and associate load. More particularly, the invention relates to an attachment to the rack that diverts air around the rack and load when the vehicle is moving at speed.

2. Discussion of Related Art

Automakers have been interested in aerodynamics dating back to at least 1934. With the need to improve fuel economy increasing over recent years for many reasons, aerodynamics in vehicles have received great attention as well as significant progress.

One common approach to reduce a vehicle's aerodynamic drag is to decrease its cross-sectional area. This may prove a simple and efficient approach for many vehicles, but it does not address a common problem associated with commercial work vehicles. Commercial work vehicles need to maintain a large size for utilitarian purposes. Many of these vehicles incorporate added structures to assist in the transport of various goods.

For example, a painter may need to transport various ladders on his vehicle. A glass repairman may need to transport large sections of glass sheet. A carpenter may need to transport long lengths of lumber. In these situations, the load is typically attached to a rack mounted on the exterior of the vehicle. The rack rods are typically a tubular structure attached to the roof of the vehicle, but alternatively may be constructed in a variety of shapes, such as in a generally L-shaped, or alternatively generally rectangular prism-shaped rods. The load may then be attached to the rack for secured transport.

Unfortunately, the added load to the exterior of the vehicle increases the vehicle's cross-sectional area and the associated aerodynamic drag. The main detriment of increased aerodynamic drag is lower fuel economy. As long as fuel costs continue to rise, there will be an increased need to lower aerodynamic drag.

The aerodynamic drag of a vehicle is measured by the coefficient of drag. The coefficient of drag is a measurement of how easily a vehicle moves through the air. The higher the coefficient of drag, the more air resistance there will be when moving through the air. For a full-size truck, a change in drag coefficient of 0.01 is approximately equal to an improvement in fuel economy of 0.1 mpg on the combined city/highway driving cycle. The same drag coefficient reduction can improve a car's fuel economy by approximately 0.2 mpg. The aerodynamic drag, or the force acting against a car by the air it moves, is a function of the drag coefficient multiplied by the frontal area multiplied by the density of air multiplied by speed squared.

Speed clearly is a significant factor in improving fuel economy as it is exponentially factored in the equation. Maintaining a low speed, however, increases a company's travel times and increases costs. As a result, there is a great need to focus on the frontal area and drag coefficient of the vehicle to increase fuel economy of a commercial work vehicle.

In order to improve a vehicle's coefficient of drag, changes to the frontal area that impacts the air must be considered. Conventional vehicle rack attachments introduce a significant amount of drag and, as a result, there is a great need to minimize not only the coefficient of drag created by the rack, but also to reduce the coefficient of drag caused by the load attached to said rack. Known inventions focused on diverting oncoming air away from the roof rack do not sufficiently address the loads secured to the rack. There is, therefore, a need to provide an improved air deflector ladder rack attachment that deflects oncoming air away from both the rack and the load attached thereto, which thereby increases fuel economy by reducing the vehicle's coefficient of drag.

### SUMMARY OF THE INVENTION

The inventive coefficient of drag improvement attachment is an aerodynamic shape, preferably made of UV protected high density polyethylene plastic, though other rigid structural materials have been contemplated such as metal, PVC, wood or the like. The attachment may be made of any thickness, but preferably is approximately 3/16 of an inch thick. Other thicknesses are contemplated and do not depart of the inventive design. The attachment may also be any color, but preferably is a natural shade of white. It is contemplated that purchasers of the attachment may have a choice of a variety of colors to which the attachment may be colored, for example to match the color of a vehicle. The attachment may also be covered with a graphic wrap or painted with any design, saying, logo, or contact information.

The attachment may be connected to a ladder rack by drilling holes through both the attachment and ladder rack. Fasteners, such as common through bolts, may then be used to secure the attachment to the rack with a skeletal frame. However, other fasteners have been contemplated, such as rivets, screws, pegs, ties, clamps, or the like. The frame may, for example, be made of two or more generally straight approximately 1 inch diameter tubes, but other sizes and shapes are envisioned as well, such as an alternative embodiment which utilizes approximately ¾ inch diameter tubes, but again it may be larger or smaller without departing from the spirit of the invention. An alternative to tubes for the frame is generally L-shaped rods, or rectangular rods. This would allow for precise placement as well, without departing from the spirit of the invention. The tubes or rods may be of any generally rigid material, such as metal, PVC, wood, polymer, composite material, or the like. Preferably the tubes are made of metal. The wall thickness of the tubes may be around 0.065 inches, but variations of the size will not depart from the inventive design. Preferably, the frame is constructed from a weather-resistant material such as zinc plated steel, stainless steel, etc.

The frame of the attachment may be connected by drilling holes and using a fastener such as for example preferably carriage bolts with a lock washer and nut, but alternatives such as a stove bolt, a screw, a rivet, a peg, or the like may also be used. The frame will then attach to the vehicle's ladder rack with fasteners on each side. These fasteners may be U-bolts, clamps, J-bolts, threaded rods, or any other fastener. A customer could also drill holes through the frame and ladder rack and secure with fasteners, preferably those such as bolts. A custom bracket may also be designed to fit certain vehicles. The frame may also be secured to the mold, at various widths, to accommodate a variety of ladder rack designs. Also, different length ladders or other loads may be placed on a ladder rack to which the invention will also improve the coefficient of drag. Another method contemplated is to have slots in the attachment frame, which will allow for ease of installation, and quick modification of location position on the ladder rack.

For longer loads, the invention may be re-located farther in front of the ladder rack. In that situation, a longer metal frame may be used. In sum, the width and length of the invention may be fully adjustable per situational demands. This allows the air drag improvement attachment to be installed on either new or existing ladder racks.

### BRIEF DESCRIPTION OF THE DRAWINGS

Preferred exemplary embodiments of the invention are illustrated in the accompanying drawings in which like reference numerals represent like parts throughout, and in which:

FIG. 1 shows a side view of the prior art in use;

FIG. 2 shows a side view of the inventive attachment in use;

FIG. 3 shows a front perspective view of the attachment of FIG. 2 attached to a partial view of a ladder rack;

FIG. 4 shows a rear perspective view of the attachment of FIG. 2;

FIG. 5 shows a top view of the attachment of FIG. 2;

FIG. 6 shows a bottom view of the attachment of FIG. 2;

FIG. 7 shows a left side view of the attachment of FIG. 2;

FIG. 8 shows a right side view of the attachment of FIG. 2;

FIG. 9 shows a front view of the attachment of FIG. 2;

FIG. 10 shows a rear view of the attachment of FIG. 2; and

FIG. 11 shows one alternative embodiment, wherein the attachment frame additionally comprises adjustment slots.

### DETAILED DESCRIPTION OF THE PREFERRED EMBODIMENTS

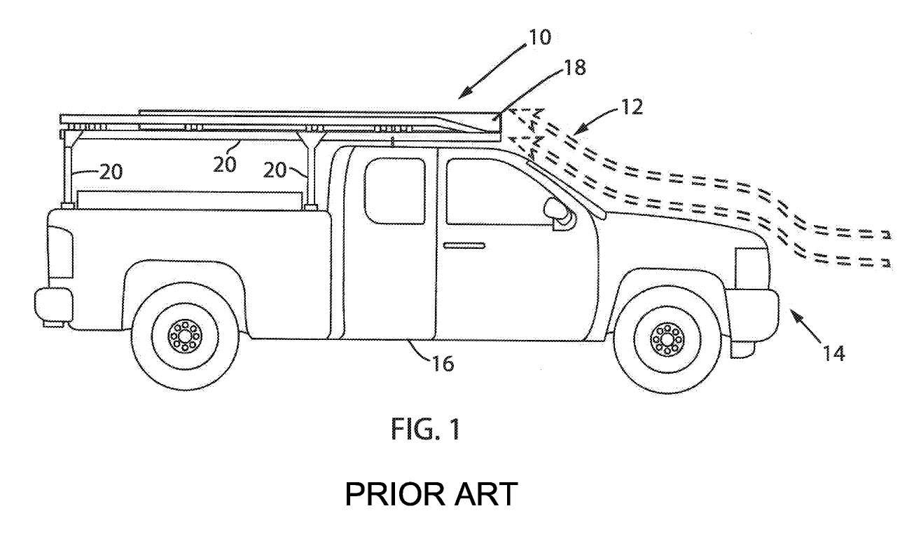

Referring now to FIG. 1, the prior art 10 is shown. In this conventional arrangement, a ladder rack 20 is attached to a vehicle 16. The wind flow 12, as the vehicle travels forward, encounters the front of the vehicle 14 and creates a high pressure zone in the windshield area. The ladder rack 20 and ladder 18 attached thereto substantially increase the surface area of vehicle 16 and as a result increase the coefficient of drag. The coefficient of drag is substantially raised as the ladder rack 20 and the associated load, attached in this example as a ladder 18, do not have an aerodynamically designed contour. Known ladder racks 20 and ladder 18 are commonly constructed of rigid materials with right angles or other shapes that are easy and inexpensive to manufacture. The increased coefficient of drag creates a drag force as the high pressure zone is encountered. The net result is that more energy is required to be exerted to overcome this drag force. The energy exerted to overcome this drag force is in the form of fuel consumption.

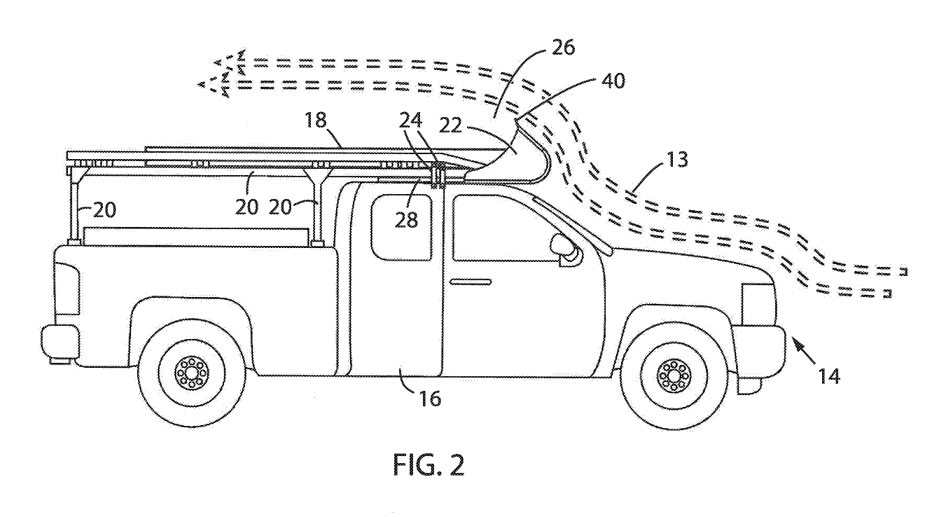

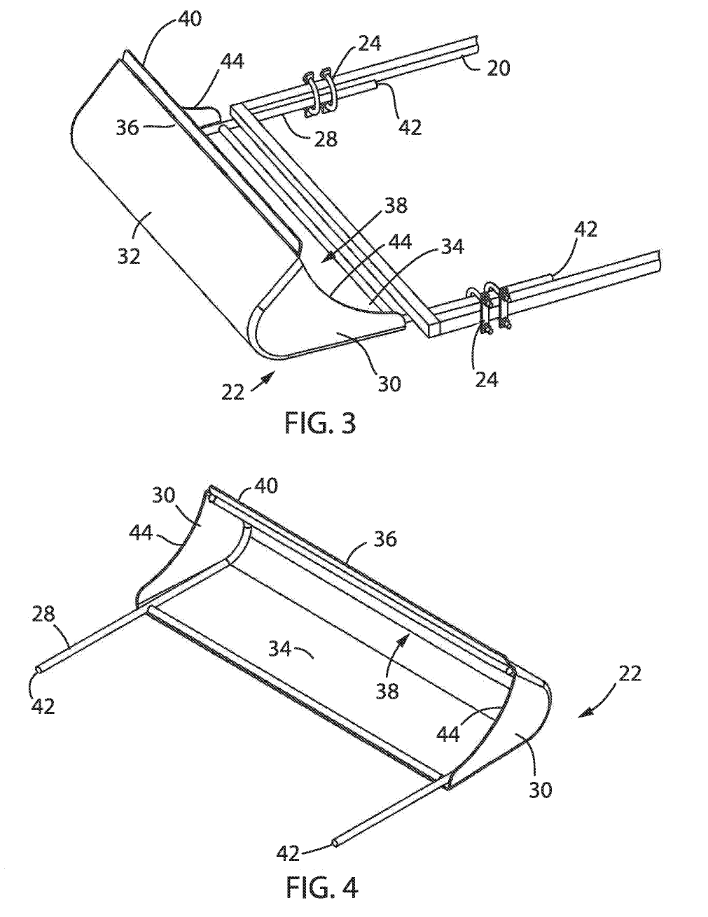

The attachment 22 as shown in FIGS. 2-4 is intended to be affixed to a vehicle 16 such as one functioning as a commercial truck. The vehicle 16 typically includes a permanently mounted rack such as a ladder rack 20. The attachment 22 will not interfere with the loading or unloading of the loads on the ladder rack 20 because of its mounting location on the front of the rack. The location of the attachment 22, at the front of a ladder rack 20, allows it to perform the intended function of creating adjusted wind flow 13, as depicted in FIG. 2. This is achieved by forming an attachment body 32, illustrated in FIG. 3, in an aerodynamic shape for the purpose of more smoothly directing air around the ladder rack 20 and the associated load. This also increases the safety of the attached load as it is not jostled around by the wind flow 12, as shown, for example, in FIG. 1. In one alternative embodiment of the present invention, slots may be formed, shaped, or otherwise cut at or near the end of the attachment frame 28.

For example, wind flow 12 has a tendency to get under the loads affixed to the ladder rack 20. The wind flow 12 can therefore lift the load off of the ladder rack 20 and impose a safety risk to the driver of the vehicle 16 or surrounding traffic. The load can also act as a sail catching the wind flow 12 and causing control of the vehicle 16 to become more difficult.

Referring now to FIG. 2, the inventive attachment 22 is shown affixed to a similar ladder rack 20. The attachment 22 is designed such that it may be attached to any ladder rack 20 with attachment fasteners 24. The attachment fasteners 24 may include any known fasteners such as bolts, screws, or the like, but, preferably, are U-bolts that clamp an attachment frame 28 to the ladder rack 20.

Wind still approaches the front of the vehicle 14 as it does without the attachment 22, but the addition of the attachment 22 creates an adjusted wind flow 13 that is diverted around and over any load attached to the ladder rack 20 which minimizes or prevents the above-mentioned safety concerns. Loads attached to the ladder rack 20 are therefore more secure and driver control of the vehicle 16 is maintained.

As discussed above, the inventive attachment 22 mounts to the existing ladder rack 20 and creates adjusted wind flow 13 that curves around and over the ladder rack 20 and the ladder 18, or any other load on the ladder rack 20. This adjusted wind flow 13 is due to the unique shape of the attachment 22 as well as the attachment spoiler 40 attached thereto, as shown in FIGS. 3-4. As the adjusted wind flow 13 flows over the ladder rack 20 and the ladder 18, a wind deflection pocket 26 is created which assists in removing the ladder rack 20 and ladder 18 from the adjusted wind flow 13 throughout the length of the vehicle 16. The attachment 22 is designed with a unique shape to minimize the coefficient of drag which improves fuel economy beyond that of what is achievable with just the ladder 18 and ladder rack 20. The attachment 22 may also be sized larger than depicted so as to accommodate for larger loads, such as boxes or other bulky items.

The attachment 22 may also be used to adjust wind flow 13 when transporting any number of items of the ladder rack 20. The attachment 22 is not limited to use with ladders 18, but can also adjust wind flow 13 when luggage, sports equipment, building materials, or the like are transported on the ladder rack 20. Since the attachment fasteners 24 are designed to be universal, the attachment 22 may be slid along the ladder rack 20 to accommodate for longer or shorter loads as well.

For example, as seen in FIGS. 3 and 4, the attachment 22 includes the attachment frame 28 that is constructed in a generally tubular shape. The attachment frame 28 may be steel, aluminum, fiberglass, or resin tubing, but is preferably rigid to maintain structural integrity at vehicle operating speed. The attachment body 32 is shaped to conform to the shape of the attachment frame 28, as best seen in FIG. 4, and may be fastened to the attachment frame 28 with any known fasteners or adhesives. The contour of the attachment body 32 provides an attachment pocket 38 which offers significant protection from drag forces. As a result, it is desirable to slide any loads on the ladder rack 20 within the attachment pocket 38 so that the aerodynamic contour of the attachment 22 encounters the oncoming wind, and creates an adjusted wind flow 13, shown in FIG. 2, as opposed to the load itself facing the wind flow 12 as in FIG. 1.

The attachment frame 28 includes attachment legs 42 which may be any length to better accommodate attachment to the ladder rack 20 with the attachment fasteners 24. For example, when transporting longer ladders, longer attachment legs 42 may be desirable to extend the attachment body 32 farther to the front of the vehicle 14 (see FIG. 2). When transporting other materials such as building materials, it may be desirable to attach the attachment frame 28 to the ladder rack 20 such that the attachment body 32 is closer to the ladder rack 20, as shown in FIG. 3 for example.

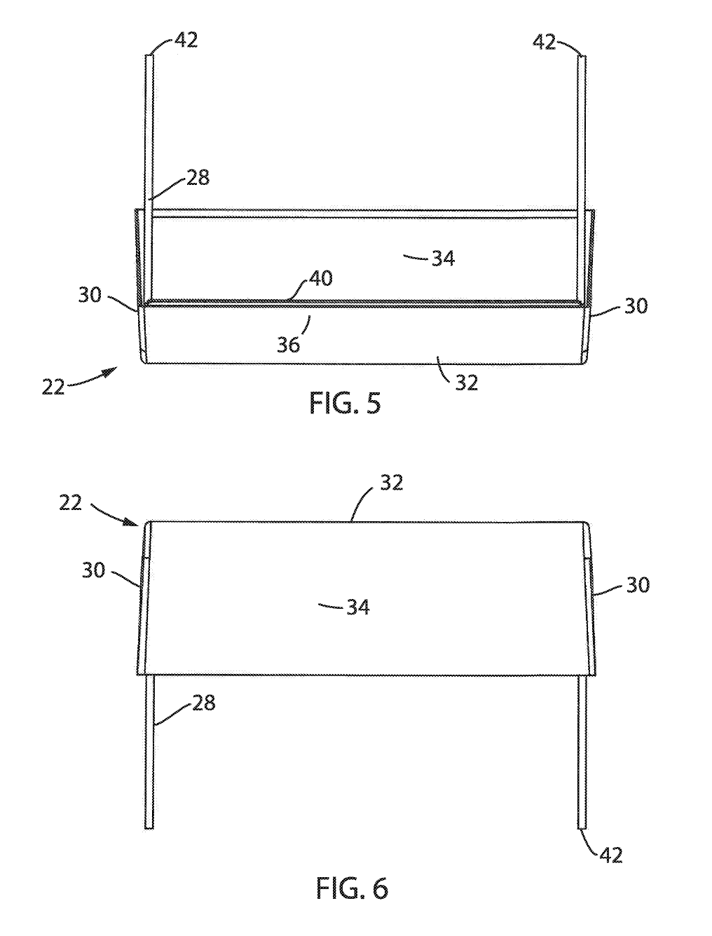

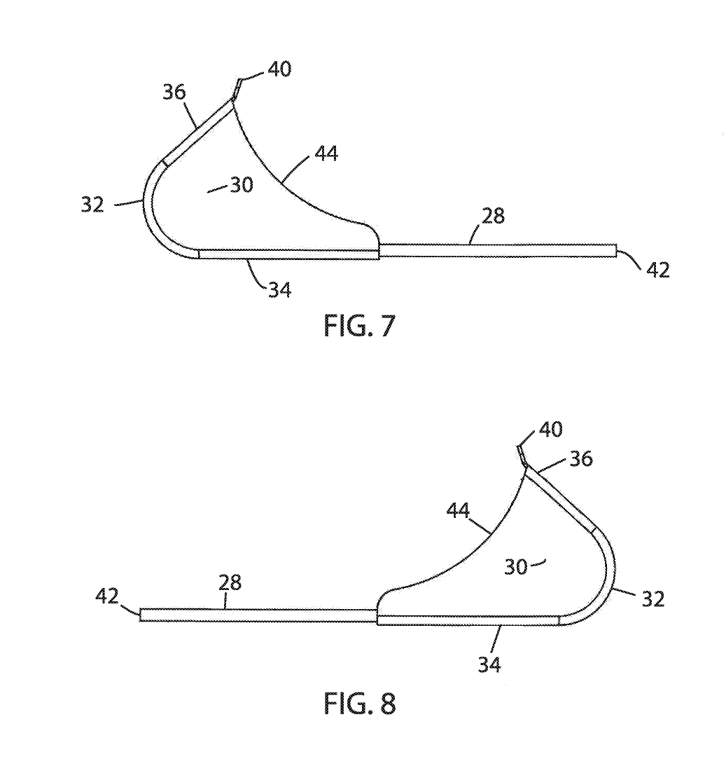

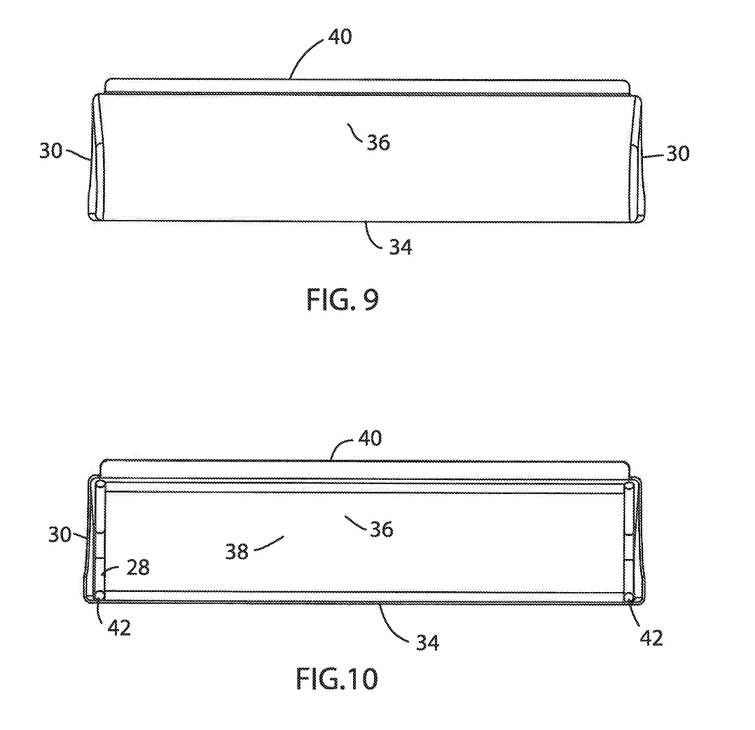

Referring now to FIGS. 5-10, the attachment 22 is shown in various views. As discussed above, the attachment body 32 is attached to the attachment frame 28 in such a manner that enables it to contour to the shape of the attachment frame 28. The attachment frame 28 is thus manufactured to be rigid and include a shape that produces a low coefficient of drag, as best shown in FIGS. 7 and 8. The attachment floor 34, shown in FIGS. 3-10, extends down a portion of the attachment legs 42 to increase the size of the attachment pocket 38, and thus prevent on-coming adjusted wind flow 13, depicted in FIG. 2, from entering the attachment pocket 38. The overall size of the attachment floor 34 therefore may be extended or shortened when manufacturing the attachment 22 and is not limited to the proportions shown.

Similarly, attachment sides 30, shown in FIGS. 3-10, prevent the adjusted wind flow 13 from getting around the attachment sides 30 and encroaching on the attachment pocket 38. Preferably, the attachment sides 30 include a scalloped portion 44 which also lessens the coefficient of drag. The scalloped portion 44 may be generally parabolic, and may mimic the shape of the attachment body's frame and/or angle. The attachment 22 is not, however, limited to this particular shape, and other shapes do not depart from the spirit of the attachment 22.

The top of the attachment 36 further includes an attachment spoiler 40 which may be affixed to the attachment 22 or may be formed as part of the attachment body 32. It is envisioned that the attachment spoiler 40 may also be formed in any other shape known to lessen the coefficient of drag, depending on the size of the load affixed to the ladder rack 20. For example, when transporting large objects, a taller attachment spoiler 40 may be affixed to the top of the attachment 36 thus further increasing the size of the attachment pocket 38 and enlarging the protective wind deflection pocket 26, as shown in FIG. 2.

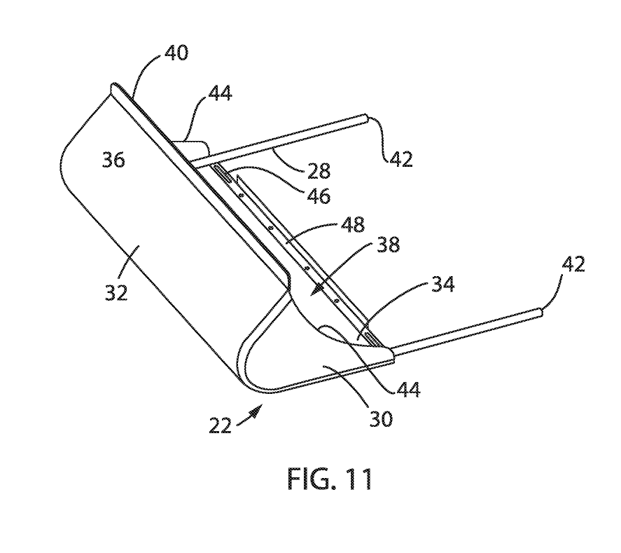

An alternative embodiment is shown in FIG. 11, in which the attachment floor 34 has an end which is adjustable with the addition of slots 46. These slots 46 are located on an angled bar 48. The angled bar is constructed of any rigid material, preferably a metal such as aluminum. The thickness of this angled bar 48 may be approximately ⅛ inch such that there is a sufficient strength-to-weight ratio. However, other embodiments may utilize an angled bar(s) 48 that is different without departing from the spirit of the present invention. The slots 46 are a mechanism in which the attachment 36 may be adjusted during and after installation on the ladder rack 20. For example, the attachment 36 may be adjusted off-center on a ladder rack 20. The angled bar 48 is an alternative method which allows for additional compression strength due to wind, load weight, or other external factors.

Although the best mode contemplated by the inventors of carrying out the present invention is disclosed above, practice of the present invention is not limited thereto. It will be manifest that various additions, modifications, and rearrangements of the aspects and features of the present invention may be made in addition to those described above without deviating from the spirit and scope of the underlying inventive concept.

It is appreciated that many changes and modifications could be made to the invention without departing from the spirit thereof Some of these changes will become apparent from the appended claims. It is intended that all such changes and/or modifications be incorporated in the appending claims.

I claim:

1. An apparatus for reducing aerodynamic drag of a vehicle, said apparatus comprising:
a rigid attachment frame with at least two attachment legs extending parallel to one another, wherein the attachment frame may be movably mounted to a vehicle rack;
an aerodynamically shaped attachment body having a generally curved front face, a bottom floor extending from a distal end of the front face, and a parallel pair of attachment side ends extending perpendicular from the bottom floor, wherein the attachment body is coupled to a distal end of the attachment frame;
an attachment pocket formed in an interior of the attachment body; and
an attachment spoiler coupled on a top of the generally curved front face of the attachment body;
wherein the attachment body diverts an oncoming air stream away from the attachment pocket when the vehicle is in motion.

2. The apparatus of claim 1, wherein the attachment spoiler is formed as part of the attachment body.

3. The apparatus of claim 1, wherein the attachment frame is mounted on the top of the vehicle and on the front of the vehicle rack.

4. The apparatus of claim 1, wherein the attachment frame legs are formed in a generally tubular shape.

5. The apparatus of claim 1, wherein the attachment frame legs are formed in a generally L-shape.

6. The apparatus of claim 4, further comprising slots for frame adjustment. The apparatus of claim 5, further comprising slots for frame adjustment.

7. The apparatus of claim 5, further comprising slots for frame adjustment.

8. The apparatus of claim 1, wherein the attachment sides include a scalloped portion.

9. The apparatus of claim 1, wherein the attachment body is constructed of a material selected from the group consisting of metal, PVC, wood, and high density polyethylene plastic.

10. A method for reducing aerodynamic drag on a moving vehicle, the method comprising:
mounting an aerodynamically shaped apparatus to a vehicle rack;
selecting a mounting location for the aerodynamically shaped apparatus on the vehicle rack;
fastening the aerodynamically shaped apparatus to the vehicle rack at the selected mounting location;
forming a generally windproof pocket within the aerodynamically shaped apparatus; and
placing an associated load at least partially within the generally windproof pocket within the aerodynamically shaped apparatus.

11. The method of claim 10, wherein the aerodynamically shaped apparatus includes an attachment body, attachment frame legs, attachment sides, and an attachment frame.

12. The method of claim 11, wherein the attachment frame is mounted on the top of the vehicle and on the front of the vehicle rack.

13. The method of claim 10, wherein the attachment frame legs are formed in a generally tubular shape.

14. The method of claim 11, wherein the attachment frame legs are formed in a generally L-shape.

15. The method of claim 11, wherein the attachment sides include a scalloped portion.

16. The method of claim 11, further comprising a spoiler extending from a top edge of the attachment body.

17. The method of claim 16, wherein the spoiler is formed integrally with the attachment body.

18. The apparatus of claim 11, wherein the attachment body is constructed of a material selected from the group consisting of metal, PVC, wood, and high density polyethylene plastic.

19. An attachment for a vehicle comprising:
a rigid, metal frame with two attachment legs extending parallel to one another, configured for securement to a vehicle rack;
an aerodynamically-shaped attachment body constructed of a material selected from the group consisting of metal, PVC, wood, and high density polyethylene plastic, the attachment body having a generally curved front face, a bottom floor extending from a distal end of the generally curved front face, and a parallel pair of attachment side ends extending perpendicular from the bottom floor, wherein the attachment body is coupled to a distal end of the attachment frame;
a generally windproof pocket formed within an interior of the generally curved front face of the attachment body; and
an attachment spoiler coupled on a top of the generally curved front face of the attachment body;
wherein the attachment body diverts an oncoming air stream away from the attachment pocket when the vehicle is in motion;
wherein the metal frame is fastened to the vehicle rack with bolts; and
wherein the attachment is mounted to a vehicle rack on a roof of a vehicle.

20. The attachment of claim 19, wherein each attachment leg further comprises a slot for frame adjustment, and wherein the two attachment legs are composed in a shape selected from the group consisting of tubular, L-shaped, and rectangular-prism.
